(19) United States
(12) Patent Application Publication
(10) Pub. No.: US 2017/0011707 A1
(43) Pub. Date: Jan. 12, 2017

(54) INTERFACE ADJUSTMENT METHOD AND TERMINAL

(71) Applicant: Tencent Technology (Shenzhen) Company Limited, Shenzhen (CN)

(72) Inventors: Beixia HUANG, Shenzhen (CN); Baike LIN, Shenzhen (CN)

(21) Appl. No.: 15/270,735

(22) Filed: Sep. 20, 2016

Related U.S. Application Data
(63) Continuation of application No. PCT/CN2015/075132, filed on Mar. 26, 2015.

(30) Foreign Application Priority Data
Mar. 27, 2014 (CN) 201410119836.3

(51) Int. Cl. G09G 5/00; G06F 3/0481; G06F 1/32

(52) U.S. Cl. CPC G09G 5/006; G06F 1/3287; G06F 1/3265; G06F 1/3218; G06F 3/04817

(57) ABSTRACT

An interface adjustment method includes: switching from a standby state to a work state or from a power-off state to a work state in response to a start operation of a user if the start operation is detected, and determining a current system time of a terminal; looking up a correspondence table of time and an illumination shadow angle, and determining an illumination shadow angle corresponding to the current system time of the terminal; and adjusting, according to the illumination shadow angle corresponding to the current system time of the terminal, an interface currently displayed by the terminal, so that the terminal can adjust the interface according to the system time.

### FIELD OF THE TECHNOLOGY

This application is a continuation application of International Application No. PCT/CN2015/075132, titled “INTERFACE ADJUSTMENT METHOD AND TERMINAL”, filed on Mar. 26, 2015, which claims priority to Chinese Patent Application No. 201410119836.3, titled “INTERFACE ADJUSTMENT METHOD AND TERMINAL”, filed with the Chinese State Intellectual Property Office on Mar. 27, 2014, both of which are incorporated by reference in their entireties.

The present disclosure relates to an interface adjustment method and a terminal.

### BACKGROUND OF THE DISCLOSURE

Along with the gradual declining of the market of traditional small-screen keypad mobile phones, large-screen touch screen mobile phones, especially smart phones are increasingly popular in the market. Capturing the market of large-screen touch screen mobile phones has currently become a major objective of all mobile phone manufacturers, and improving competitiveness of a product is undoubtedly a major method for the mobile phone manufacturers to capture the market of large-screen touch screen mobile phones. With the development of technologies, it is deeply aware that improving user experience plays a very important role in improving competitiveness of a mobile phone product, and a man-machine interaction interface of a mobile phone, that is, a UI interface of the mobile phone, plays an important role in terms of user experience of the mobile phone. A design core of the UI interface of the mobile phone is to be user-friendly to make users satisfactory in use.

For a random mainstream application in the current market, whether a mobile terminal or a personal computer terminal, a UI interface thereof mostly presents a static view, and if a user has visual fatigue after long-time use, it is generally solved by replacing a skin.

Currently, some dynamic effects are achieved for UI interfaces of some applications, thereby achieving the objective of making the interface vivid by looping the dynamic effects. However, looping the dynamic effects consumes a lot of electricity, and shortens the standby time of the terminal.

### SUMMARY

An exemplary interface adjustment method includes:

switching from a standby state to a work state or from a power-off state to a work state in response to a start operation of a user if the start operation is detected, and determining a current system time of a terminal;

looking up a correspondence table of time and an illumination shadow angle, and determining an illumination shadow angle corresponding to the current system time of the terminal; and

adjusting, according to the illumination shadow angle corresponding to the current system time of the terminal, an interface currently displayed by the terminal.

A exemplary terminal includes:

a starting and determining unit, configured to switch from a standby state to a work state or from a power-off state to a work state in response to a start operation of a user if the start operation is detected, and determine a current system time of the terminal;

a searching unit, configured to look up a correspondence table of time and an illumination shadow angle after the starting and determining unit determines the current system time of the terminal, and determine an illumination shadow angle corresponding to the current system time of the terminal; and

an adjusting unit, configured to adjust, after the searching unit determines the illumination shadow angle corresponding to the current system time of the terminal, according to the illumination shadow angle corresponding to the current system time of the terminal, an interface currently displayed by the terminal.

### BRIEF DESCRIPTION OF THE DRAWINGS

FIG. 1 is a schematic diagram of an interface adjustment method according to an embodiment of the present disclosure;

FIG. 2 is another schematic diagram of an interface adjustment method according to an embodiment of the present disclosure;

FIG. 3a is a schematic diagram of an interface of a mobile phone after adjustment according to an embodiment of the present disclosure;

FIG. 3b is another schematic diagram of an interface of a mobile phone after adjustment according to an embodiment of the present disclosure;

FIG. 3c is another schematic diagram of an interface of a mobile phone after adjustment according to an embodiment of the present disclosure;

FIG. 4 is a schematic structural diagram of a terminal according to an embodiment of the present disclosure; and

FIG. 5 is another schematic structural diagram of a terminal according to an embodiment of the present disclosure.

### DESCRIPTION OF EMBODIMENTS

Embodiments of the present disclosure provide an interface adjustment method and a terminal, which are used to solve the problem in the existing technology that looping dynamic effects of an interface consumes a lot of electricity.

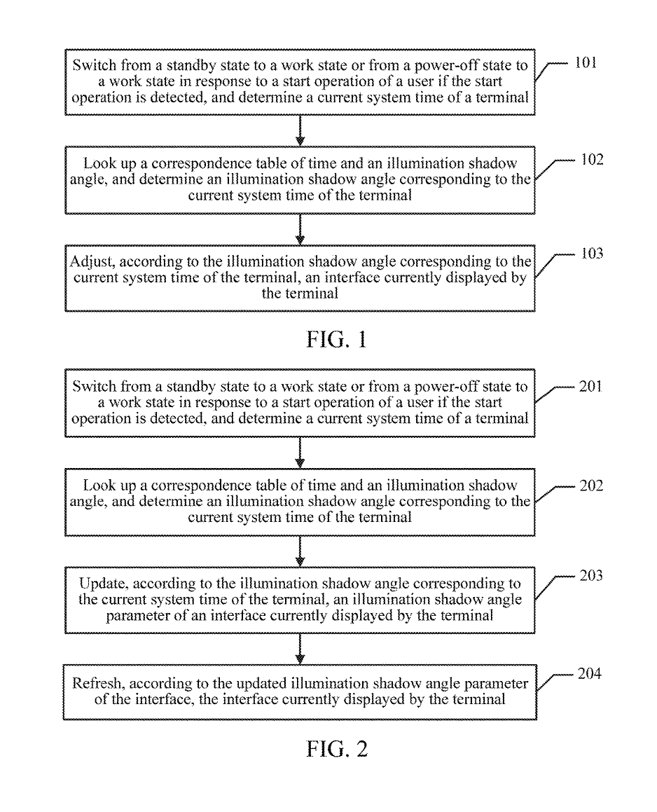

Refer to FIG. 1, which illustrates an embodiment of an interface adjustment method according to an embodiment of the present disclosure, including:

101: Switch from a standby state to a work state or from a power-off state to a work state in response to a start operation of a user if the start operation is detected, and determine a current system time of a terminal.

In this embodiment of the present disclosure, the terminal may be a mobile terminal, such as a mobile phone, a tablet computer, or a personal computer.

In this embodiment of the present disclosure, when the terminal is in a standby state, the terminal does not adjust the interface so to avoid power consumption, and when the terminal is in a work state, to provide better experience for the user, the terminal may adjust the interface in real time, or may adjust the interface at intervals.

In this embodiment of the present disclosure, when the terminal is in a standby state or in a power-off state, if a start operation of a user is detected, the terminal switches from the standby state to a work state or from the power-off state to a work state in response to the start operation, and determines a current system time of the terminal, the current system time of the terminal being provided by an internal time apparatus of the terminal. The start operation refers to an operation of a user triggering a terminal to switch to a work state when the terminal is in a standby state or a power-off state.

It should be noted that, in this embodiment of the present disclosure, the terminal is provided in advance with a switch button or other switching actions for the terminal to switch from the standby state or the power-off state to the work state. For example, the user may press a home button on a mobile phone or a start button of a mobile phone, after the user presses the home button on the mobile phone or the start button of the mobile phone, the home button or the start button generates a signal input to a processor of the terminal, and after receiving the signal, the processor of the terminal switches the mobile phone from the standby state to the work state. For another example, the user may click a display interface of an IPAD in a standby state, the display interface transmits a signal generated by the click action to a processor of the IPAD, and the processor of the IPAD in the standby state receives the signal, and then switches the IPAD from the standby state to the work state. In an actual application, different devices are triggered in different manners, which are not limited herein. For another example, when the user holds down a start button at a side of a mobile phone when the mobile phone is in a power-off state, the start button generates a power-on signal, and the power-on signal triggers the mobile phone to start, thereby implementing a boot process, so that the mobile phone switches from the power-off state to the work state.

It should be noted that the interface in this embodiment of the present disclosure may be a User Interface (UI).

102: Look up a correspondence table of time and an illumination shadow angle, and determine an illumination shadow angle corresponding to the current system time of the terminal.

In this embodiment of the present disclosure, the correspondence table of the time and the illumination shadow angle is preset in the terminal, and after the terminal acquires the current system time of the terminal, the terminal looks up the correspondence table of the time and the illumination shadow angle, and determines an illumination shadow angle corresponding to the current system time of the terminal. For example, if the time is 12:00 at noon, it is determined, by looking up the correspondence table of the time and the illumination shadow angle, that the illumination shadow angle at 12:00 at noon is 95 degrees, and if the time is 6:00 PM, it is determined, by looking up the correspondence table of the time and the illumination shadow angle, that the illumination shadow angle at 6:00 PM is 180 degrees. In an actual application, the correspondence table of the time and the illumination shadow angle may be set according to specific requirements, which is not limited herein.

103: Adjust, according to the illumination shadow angle corresponding to the current system time of the terminal, an interface currently displayed by the terminal.

In this embodiment of the present disclosure, after finding the illumination shadow angle corresponding to the current system time of the terminal, the terminal adjusts, according to the illumination shadow angle corresponding to the current system time of the terminal, the interface currently displayed by the terminal.

In this embodiment of the present disclosure, if a start operation of a user is detected, a terminal switches from a standby state to a work state or from a power-off state to a work state in response to the start operation, and determines a current system time of the terminal, and after the terminal determines the current system time of the terminal, the terminal looks up a correspondence table of time and an illumination shadow angle, determines an illumination shadow angle corresponding to the current system time of the terminal, and adjusts, according to the illumination shadow angle corresponding to the current system time of the terminal, an interface currently displayed by the terminal, so that the terminal can adjust the interface according to the system time, so as to avoid the problem that looping dynamic effects of an interface consumes a lot of electricity, thereby effectively saving the electric energy.

To better understand the technical solution in this embodiment of the present disclosure, refer to FIG. 2, which illustrates an embodiment of an interface adjustment method according to an embodiment of the present disclosure, including:

201: Switch from a standby state to a work state or from a power-off state to a work state in response to a start operation of a user if the start operation is detected, and determine a current system time of a terminal.

In this embodiment of the present disclosure, when the terminal is in a standby state, the terminal does not adjust the interface so to avoid power consumption, and when the terminal is in a work state, to provide better experience for the user, the terminal may adjust the interface in real time, or may adjust the interface at intervals.

In this embodiment of the present disclosure, when the terminal is in a standby state or in a power-off state, if a start operation of a user is detected, the terminal switches from the standby state to a work state or from the power-off state to a work state in response to the start operation, and determines a current system time of the terminal, the current system time of the terminal being provided by an internal time apparatus of the terminal.

It should be noted that, in this embodiment of the present disclosure, the terminal is provided in advance with a switch button or other switching actions for the terminal to switch from the standby state or the power-off state to the work state. For example, the user may press a home button on a mobile phone or a start button of a mobile phone, after the user presses the home button on the mobile phone or the start button of the mobile phone, the home button or the start button generates a signal input to a processor of the terminal, and after receiving the signal, the processor of the terminal switches the mobile phone from the standby state to the work state. For another example, the user may click a display interface of an IPAD in a standby state, the display interface transmits a signal generated by the click action to a processor of the IPAD, and the processor of the IPAD in the standby state receives the signal, and then switches the IPAD from the standby state to the work state. In an actual application, different devices are triggered in different manners, which are not limited herein. For another example, when the user holds down a start button at a side of a mobile phone when the mobile phone is in a power-off state, the start button generates a power-on signal, and the power-on signal triggers the mobile phone to start, thereby implementing a boot process, so that the mobile phone switches from the power-off state to the work state.

In this embodiment of the present disclosure, the terminal includes a time apparatus therein, and the terminal may determine the current system time of the terminal by using the time apparatus.

202: Look up a correspondence table of time and an illumination shadow angle, and determine an illumination shadow angle corresponding to the current system time of the terminal.

In this embodiment of the present disclosure, the correspondence table of the time and the illumination shadow angle is preset in the terminal, and after the terminal acquires the current system time of the terminal, the terminal looks up the correspondence table of the time and the illumination shadow angle, and determines an illumination shadow angle corresponding to the current system time of the terminal. For example, if the time is 12:00 at noon, it is determined, by looking up the correspondence table of the time and the illumination shadow angle, that the illumination shadow angle at 12:00 at noon is 95 degrees, and if the time is 6:00 PM, it is determined, by looking up the correspondence table of the time and the illumination shadow angle, that the illumination shadow angle at 6:00 PM is 180 degrees. In an actual application, the correspondence table of the time and the illumination shadow angle may be set according to specific requirements, which is not limited herein.

203: Update, according to the illumination shadow angle corresponding to the current system time of the terminal, an illumination shadow angle parameter of an interface currently displayed by the terminal.

In this embodiment of the present disclosure, after acquiring the illumination shadow angle corresponding to the current system time of the terminal, the terminal updates, according to the angle, the illumination shadow angle parameter of the interface currently displayed by the terminal, that is, modifies an illumination shadow angle parameter of an interface configured in the terminal.

204: Refresh, according to the updated illumination shadow angle parameter of the interface, the interface currently displayed by the terminal.

In this embodiment of the present disclosure, after updating the illumination shadow angle parameter of the interface currently displayed by the terminal, the terminal refreshes, according to the updated illumination shadow angle parameter of the interface, the interface currently displayed by the terminal.

In this embodiment of the present disclosure, if the interface currently displayed by the terminal is a subject interface of the terminal, the refreshing, according to the updated illumination shadow angle parameter of the interface, the interface currently displayed by the terminal may specifically be: refreshing illumination shadow of the current subject interface of the terminal according to the updated illumination shadow angle parameter of the interface, and if the subject interface includes an application icon, further refreshing illumination shadow of the application icon on the interface according to the updated illumination shadow angle parameter of the interface.

In this embodiment of the present disclosure, if the interface currently displayed by the terminal is an interface of an application, the refreshing, according to the updated illumination shadow angle parameter of the interface, the interface currently displayed by the terminal may specifically be: refreshing the interface of the application according to the updated illumination shadow angle parameter of the interface.

In this embodiment of the present disclosure, if a start operation of a user is detected, a terminal switches from a standby state to a work state or from a power-off state to a work state in response to the start operation, and determines a current system time of the terminal; and the terminal looks up a correspondence table of time and an illumination shadow angle that is preset in the terminal, determines an illumination shadow angle corresponding to the current system time of the terminal, updates, according to the illumination shadow angle corresponding to the current system time of the terminal, an illumination shadow angle parameter of an interface currently displayed by the terminal, and refreshes, according to the updated illumination shadow angle parameter of the interface, the interface currently displayed by the terminal, so that the terminal can adjust the interface according to a change in the time, so as to avoid the problem that looping dynamic effects of an interface consumes a lot of electricity, thereby effectively saving the electric energy.

To better understand the technical solution in this embodiment of the present disclosure, a specific application scenario is described as follows:

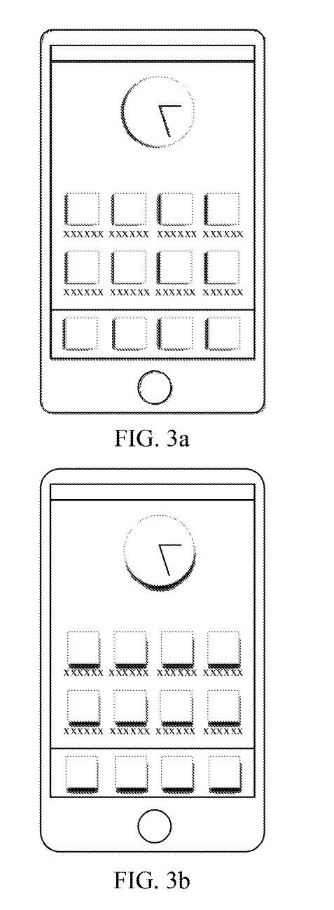

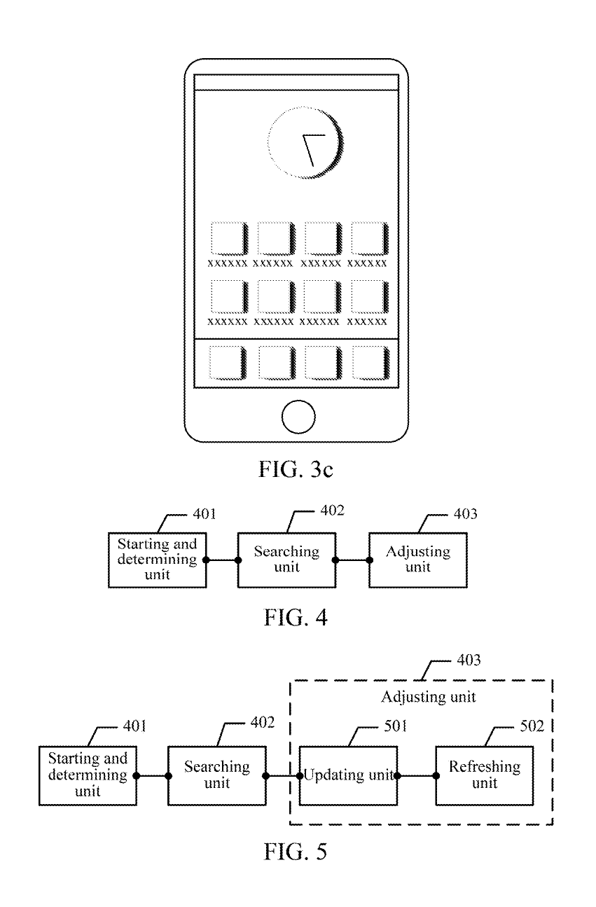

When a user turns on a mobile phone, if the mobile phone determines that a current system time of the mobile phone is 6:00 AM, an interface of the mobile phone after adjustment may be as that shown in FIG. 3a; if the mobile phone determines that a current system time of the mobile phone is 12:00 at noon, an interface of the mobile phone after adjustment may be as that shown in FIG. 3b; and if the mobile phone determines that a current system time of the mobile phone is 6:00 PM, an interface of the mobile phone after adjustment may be as that shown in FIG. 3c.

Refer to FIG. 4, which illustrates an embodiment of a structure of a terminal according to an embodiment of the present disclosure, including:

a starting and determining unit 401, configured to switch from a standby state to a work state or from a power-off state to a work state in response to a start operation of a user if the start operation is detected, and determine a current system time of the terminal;

a searching unit 402, configured to look up a correspondence table of time and an illumination shadow angle after the starting and determining unit 401 determines the current system time of the terminal, and determine an illumination shadow angle corresponding to the current system time of the terminal; and

an adjusting unit 403, configured to adjust, after the searching unit 402 determines the illumination shadow angle corresponding to the current system time of the terminal, according to the illumination shadow angle corresponding to the current system time of the terminal, an interface currently displayed by the terminal.

In this embodiment of the present disclosure, the starting and determining unit 401 in the terminal determines a current system time of the terminal; then, the searching unit 402 looks up a correspondence table of time and an illumination shadow angle to determine an illumination shadow angle corresponding to the current system time of the terminal; and finally, the adjusting unit 403 adjusts, according to the illumination shadow angle corresponding to the current system time of the terminal, an interface currently displayed by the terminal.

In this embodiment of the present disclosure, if a start operation of a user is detected, a starting and determining unit 401 switches from a standby state to a work state or from a power-off state to a work state in response to the start operation, and the terminal further determines a current system time of the terminal, looks up a correspondence table of time and an illumination shadow angle, determines an illumination shadow angle corresponding to the current system time of the terminal, and adjusts, according to the illumination shadow angle corresponding to the current system time of the terminal, an interface currently displayed by the terminal, so that the terminal can adjust the interface according to the system time, so as to avoid the problem that looping dynamic effects of an interface consumes a lot of electricity, thereby effectively saving the electric energy.

To better understand the technical solution in this embodiment of the present disclosure, refer to FIG. 5, which illustrates an embodiment of a structure of a terminal according to an embodiment of the present disclosure, including:

the starting and determining unit 401, the searching unit 402, and the adjusting unit 403 according to the embodiment shown in FIG. 4, the technical content being similar to that described in the embodiment shown in FIG. 4, which is not limited herein.

In this embodiment of the present disclosure, the starting and determining unit 401 is specifically configured to determine a current system time of the terminal if the terminal switches from a standby state to a work state; or determine a current system time of the terminal if a preset time period expires since the terminal adjusted the interface last time.

In this embodiment of the present disclosure, the adjusting unit 403 includes:

an updating unit 501, configured to update, after the searching unit 402 determines the illumination shadow angle corresponding to the current system time of the terminal, according to the illumination shadow angle corresponding to the current system time of the terminal, an illumination shadow angle parameter of the interface currently displayed by the terminal; and

a refreshing Unit 502, configured to refresh, after the updating unit 501 updates the illumination shadow angle parameter of the interface currently displayed by the terminal, according to the updated illumination shadow angle parameter of the interface, the interface currently displayed by the terminal.

In this embodiment of the present disclosure, if the interface currently displayed by the terminal is a subject interface of the terminal, the refreshing unit 502 is specifically configured to refresh illumination shadow of the current subject interface of the terminal according to the updated illumination shadow angle parameter of the interface, and if the subject interface includes an application icon, the refreshing unit 502 is further configured to refresh the illumination shadow of the application icon on the interface according to the updated illumination shadow angle parameter of the interface.

In this embodiment of the present disclosure, if the interface currently displayed by the terminal is an interface of an application, the refreshing unit 502 is specifically configured to refresh the interface of the application according to the updated illumination shadow angle parameter of the interface.

In this embodiment of the present disclosure, if a start operation of a user is detected, a starting and determining unit 401 switches from a standby state to a work state or from a power-off state to a work state in response to the start operation, and determines a current system time of a terminal, and then, a searching unit 402 looks up a correspondence table of time and an illumination shadow angle, determines an illumination shadow angle corresponding to the current system time of the terminal; then, an updating unit 501 in an adjusting unit 403 updates, according to the illumination shadow angle corresponding to the current system time of the terminal, an illumination shadow angle parameter of an interface currently displayed by the terminal, and a refreshing unit 502 refreshes, according to the updated illumination shadow angle parameter of the interface, the interface currently displayed by the terminal. The refreshing, by the refreshing unit 502, according to the updated illumination shadow angle parameter of the interface, the interface currently displayed by the terminal may specifically include that: if the interface currently displayed by the terminal is a subject interface of the terminal, the refreshing unit 502 refreshes, according to the updated illumination shadow angle parameter of the interface, illumination shadow of the current subject interface of the terminal, and if the subject interface includes an application icon, the refreshing unit 502 further refreshes, according to the updated illumination shadow angle parameter of the interface, illumination shadow of the application icon on the interface. If the interface currently displayed by the terminal is an interface of an application, the refreshing unit 502 refreshes the interface of the application according to the updated illumination shadow angle parameter of the interface.

In this embodiment of the present disclosure, if a start operation of a user is detected, a terminal switches from a standby state to a work state or from a power-off state to a work state in response to the start operation, and determines a current system time of the terminal; and the terminal looks up a correspondence table of time and an illumination shadow angle that is preset in the terminal, determines an illumination shadow angle corresponding to the current system time of the terminal, updates, according to the illumination shadow angle corresponding to the current system time of the terminal, an illumination shadow angle parameter of an interface currently displayed by the terminal, and refreshes, according to the updated illumination shadow angle parameter of the interface, the interface currently displayed by the terminal, so that the terminal can adjust the interface according to a change in the time, so as to avoid the problem that looping dynamic effects of an interface consumes a lot of electricity, thereby effectively saving the electric energy.

A person of ordinary skill in the art may understand that all or some of the steps in the method of the foregoing embodiments may be implemented by a program instructing relevant hardware. The program may be stored in a computer readable storage medium. The storage medium may be a read-only memory, a magnetic disk, an optical disc, or the like.

An interface adjustment method and a terminal provided in the present disclosure are described above in detail, and for a person of ordinary skill in the art, variations may be made on specific implementation manners and application ranges according to the spirit of the embodiments of the present disclosure. To sum up, the content of the specification should not be construed as a limit on the present disclosure.

What is claimed is:

1. An interface adjustment method, comprising processor-implemented steps, the steps comprising:
switching from a standby state to a work state or from a power-off state to a work state in response to a start operation of a user if the start operation is detected, and determining a current system time of a terminal;
looking up a correspondence table of time and an illumination shadow angle, and determining an illumination shadow angle corresponding to the current system time of the terminal; and
adjusting, according to the illumination shadow angle corresponding to the current system time of the terminal, an interface currently displayed by the terminal.

2. The method according to claim 1, wherein the adjusting, according to the illumination shadow angle corresponding to the current system time of the terminal, an interface currently displayed by the terminal comprises:
updating, according to the illumination shadow angle corresponding to the current system time of the terminal, an illumination shadow angle parameter of the interface currently displayed by the terminal; and
refreshing, according to the updated illumination shadow angle parameter of the interface, the interface currently displayed by the terminal.

3. The method according to claim 2, wherein if the interface currently displayed by the terminal is a subject interface of the terminal, and the refreshing, according to the updated illumination shadow angle parameter of the interface, the interface currently displayed by the terminal comprises:
refreshing illumination shadow of the current subject interface of the terminal according to the updated illumination shadow angle parameter of the interface.

4. The method according to claim 3, wherein the method further comprises:
refreshing illumination shadow of an application icon on the interface according to the updated illumination shadow angle parameter of the interface if the subject interface comprises the application icon.

5. The method according to claim 2, wherein if the interface currently displayed by the terminal is an interface of an application, the refreshing, according to the updated illumination shadow angle parameter of the interface, the interface currently displayed by the terminal comprises:
refreshing the interface of the application according to the updated illumination shadow angle parameter of the interface.

6. A terminal, comprising at least one processor, the processor executing instructions for:
switching from a standby state to a work state or from a power-off state to a work state in response to a start operation of a user if the start operation is detected, and determining a current system time of the terminal;
looking up a correspondence table of time and an illumination shadow angle after a starting and determining unit determines the current system time of the terminal, and determining an illumination shadow angle corresponding to the current system time of the terminal; and
adjusting, after a searching unit determines the illumination shadow angle corresponding to the current system time of the terminal, according to the illumination shadow angle corresponding to the current system time of the terminal, an interface currently displayed by the terminal.

7. The terminal according to claim 6, the processor further executing instructions for:
updating, after the searching unit determines the illumination shadow angle corresponding to the current system time of the terminal, according to the illumination shadow angle corresponding to the current system time of the terminal, an illumination shadow angle parameter of the interface currently displayed by the terminal; and
refreshing, after an updating unit updates the illumination shadow angle parameter of the interface currently displayed by the terminal, according to the updated illumination shadow angle parameter of the interface, the interface currently displayed by the terminal.

8. The terminal according to claim 7, if the interface currently displayed by the terminal is a subject interface of the terminal, the processor further executing instructions for: refreshing illumination shadow of the current subject interface of the terminal according to the updated illumination shadow angle parameter of the interface.

9. The terminal according to claim 8, if the subject interface comprises an application icon, the processor further executing instructions for: refreshing illumination shadow of the application icon on the interface according to the updated illumination shadow angle parameter of the interface.

10. The terminal according to claim 7, if the interface currently displayed by the terminal is an interface of an application, the processor further executing instructions for: refreshing the interface of the application according to the updated illumination shadow angle parameter of the interface.

11. A non-transitory computer readable storage medium having stored therein one or more instructions, which, when executed by a terminal, cause the terminal to:
switch from a standby state to a work state or from a power-off state to a work state in response to a start operation of a user if the start operation is detected, and determine a current system time of the terminal;
look up a correspondence table of time and an illumination shadow angle, and determine an illumination shadow angle corresponding to the current system time of the terminal; and
adjust, according to the illumination shadow angle corresponding to the current system time of the terminal, an interface currently displayed by the terminal.

12. The computer readable storage medium according to claim 11, wherein the instructions for adjusting, according to the illumination shadow angle corresponding to the current system time of the terminal, an interface currently displayed by the terminal comprise:
updating, according to the illumination shadow angle corresponding to the current system time of the terminal, an illumination shadow angle parameter of the interface currently displayed by the terminal; and
refreshing, according to the updated illumination shadow angle parameter of the interface, the interface currently displayed by the terminal.

13. The computer readable storage medium according to claim 12, wherein the instructions for refreshing, if the interface currently displayed by the terminal is a subject interface of the terminal, according to the updated illumination shadow angle parameter of the interface, the interface currently displayed by the terminal comprises:
refreshing illumination shadow of the current subject interface of the terminal according to the updated illumination shadow angle parameter of the interface.

14. The computer readable storage medium according to claim 13, further comprising instructions, which, when executed by a terminal, cause the terminal achieve to:
refresh illumination shadow of an application icon on the interface according to the updated illumination shadow angle parameter of the interface if the subject interface comprises the application icon.

15. The computer readable storage medium according to claim 12, wherein the instructions for refreshing, if the interface currently displayed by the terminal is an interface of an application, according to the updated illumination shadow angle parameter of the interface, the interface currently displayed by the terminal comprises:
refreshing the interface of the application according to the updated illumination shadow angle parameter of the interface.
